(19) United States
(12) Patent Application Publication
(10) Pub. No.: US 2015/0002624 A1
(43) Pub. Date: Jan. 1, 2015

(54) VIDEO SIGNAL PROCESSING DEVICE AND VIDEO SIGNAL PROCESSING METHOD

(71) Applicants: Haruko Terai, Osaka (JP); Chikara Gotanda, Osaka (JP); Ryuichi Shibutani, Osaka (JP)

(72) Inventors: Haruko Terai, Osaka (JP); Chikara Gotanda, Osaka (JP); Ryuichi Shibutani, Osaka (JP)

(73) Assignee: PANASONIC CORPORATION, Osaka (JP)

(21) Appl. No.: 14/372,907

(22) PCT Filed: Jan. 20, 2012
(86) PCT No.: PCT/JP2012/000349

§ 371 Date: Jul. 17, 2014

(51) Int. Cl. H04N 13/00

(52) U.S. Cl. CPC H04N 13/0029
USPC 348/42

(57) ABSTRACT

A video signal processing device includes: an extraction unit which extracts, from each frame of an input video including a right-eye image and a left-eye image, one of the right-eye image and the left-eye image as an extracted image; and an image enlargement processing unit which (i) forms an interpolated image by enlarging the extracted image extracted by the extraction unit, through pixel interpolation using a pixel included in a previous frame, and (ii) outputs the interpolated image, the previous frame being a frame previous to the frame including the extracted image.

### TECHNICAL FIELD

The present invention relates to a video signal processing device and a video signal processing method, and typically to a video signal processing device and a video signal processing method which convert a three-dimensional video signal into a two-dimensional video signal. The three-dimensional video signal includes a left-eye video signal and a right-eye video signal, and allows three-dimensional viewing.

### BACKGROUND ART

Conventionally, a stereoscopic image display device is known which offers stereoscopic effect to the viewer by presenting a different video to the left eye and the right eye of the viewer. Furthermore, several schemes are known as the scheme for transmitting a three-dimensional video including two images which are the left-eye image and the right-eye image. Among them, well-known schemes include a side-by-side scheme in which the two images are combined in the horizontal direction and transmitted, and a top-and-bottom scheme in which the two images are combined in the vertical direction and transmitted.

Here, several techniques have been proposed for converting the transmitted three-dimensional video into the two-dimensional video. For example, as in Patent Literature (PTL) 1, there is a technique for interpolating, in the horizontal direction, pixels into the image transmitted by the side-by-side scheme. FIG. 6 illustrates the conventional video signal processing. In this manner, an image having the proper number of pixels in the horizontal direction is generated from a right-eye image or a left-eye image having number of pixels in the horizontal direction half the original image.

### CITATION LIST

### Patent Literature

[PTL 1] Japanese Unexamined Patent Application Publication No. 2010-068315

### SUMMARY OF INVENTION

### Technical Problem

However, with the conventional pixel interpolating processing, band attenuation may be caused for the frequency of the input image.

Specifically, the fineness of the original image may be lost. Such an issue is likely to be acknowledged by the viewer especially when the pixel interpolation processing is performed on the still image. In other words, there is an issue that the viewer is likely to have uncomfortable feeling as a result of being presented with the pixel-interpolated video.

The present invention has been conceived in view of the above issue, and has an object to provide a video signal processing device and a video signal processing method which reduce the uncomfortable feeling caused by the pixel interpolation.

### Solution to Problem

A video signal processing device according to an aspect of the present invention enlarges an image and outputs the enlarged image.

Specifically, the video signal processing device includes: an extraction unit configured to extract, from each frame of an input video including a right-eye image and a left-eye image, one of the right-eye image and the left-eye image as an extracted image; and an image enlargement processing unit configured to (i) form an interpolated image by enlarging the extracted image extracted by the extraction unit, through pixel interpolation using a pixel included in a previous frame, and (ii) output the interpolated image, the previous frame being a frame previous to the frame including the extracted image.

With the above structure, the interpolation is performed using the image in the previous frame which is less likely to lower the fineness of the original image. This allows outputting an image which is less likely to make the viewer have uncomfortable feeling as compared with the video obtained by simply increasing the pixel in the current frame in the horizontal direction.

As an example, the video signal processing device may further include a detection unit configured to detect, for each of a plurality of pixels included in the extracted image, whether a current pixel is a moving pixel which moves no less than a predetermined threshold or a still pixel which moves less than the predetermined threshold. Furthermore, the image enlargement processing unit may be configured to generate, for each of the pixels included in the extracted image: when it is determined by the detection unit that the current pixel is the moving pixel, a pixel value of a pixel adjacent to the current pixel in the interpolated image using a pixel value of the current pixel; and when it is determined by the detection unit that the current pixel is the still pixel, a pixel value of a pixel adjacent to the current pixel in the interpolated image using a pixel value of a pixel that is included in the previous frame and corresponds to the current pixel.

As another example, the video signal processing device may further include a detection unit configured to detect, for each of a plurality of pixels included in the extracted image, a movement amount which is a magnitude of movement of a current pixel. Furthermore, the image enlargement processing unit may be configured to (i) blend, for each of the pixels included in the extracted image, a pixel value of the current pixel and a pixel value of a pixel that is included in the previous frame and corresponds to the current pixel to increase a weight of the current pixel as the movement amount detected by the detection unit is greater, and (ii) generate a pixel adjacent to the current pixel in the interpolated image.

Furthermore, the extraction unit may be further configured to inform the enlargement processing unit of whether each frame of the input image has a side-by-side structure or a top-and-bottom structure, the side-by-side structure having the right-eye image and the left-eye image arranged in the right and left, the top and bottom structure having the right-eye image and the left-eye image arranged in the top and bottom. Furthermore, the image enlargement processing unit may be configured to: when the frame of the input video has the side-by-side structure, interpolate in the interpolated image a pixel at a position adjacent in a right-and-left direction to each pixel included in the extracted image, and when the frame of the input video has the top-and-bottom structure, interpolate in the interpolated image a pixel at a position adjacent in a top-and-bottom direction to each pixel included in the extracted image.

A video signal processing method according to an aspect of the present invention is a method of enlarging an image and outputting the enlarged image. Specifically, the video signal processing method includes: extracting, from each frame of an input video including a right-eye image and a left-eye image, one of the right-eye image and the left-eye image as an extracted image; and (i) forming an interpolated image by enlarging the extracted image extracted in the extracting, through pixel interpolation using a pixel included in a previous frame, and (ii) outputting the interpolated image, the previous frame being a frame previous to the frame including the extracted image.

It is to be noted that the present invention can be realized not only as the video signal processing device as described above, but also as an integrated circuit which has the function of the video signal processing device and as a program which causes a computer to execute such function. It goes without saying that such a program can be distributed via a recording medium such as a CD-ROM or the like or a transmission medium such as the Internet.

### Advantageous Effects of Invention

With the present invention, since the interpolation is performed using the image in the previous frame, the fineness of the original image is less likely to be lowered as compared with that of the interpolation scheme in which the pixel in the current frame is simply increased in the horizontal direction. As a result, a video can be output which is less likely to make the viewer have uncomfortable feeling.

### BRIEF DESCRIPTION OF DRAWINGS

FIG. 1 is a block diagram of a video signal processing device according to Embodiment 1,

FIG. 2 is a flowchart of an image enlargement processing according to Embodiment 1.

FIG. 3 is a conceptual diagram indicating the image enlargement processing according to Embodiment 1.

FIG. 4 is a flowchart of an image enlargement processing according to Embodiment 2.

FIG. 5 is a conceptual diagram indicating the image enlargement processing according to Embodiment 2.

FIG. 6 illustrates the conventional video signal processing,

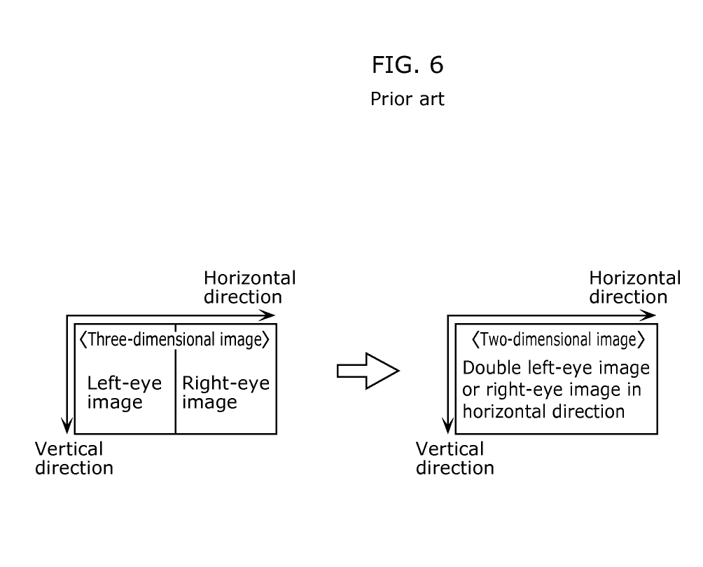

### DESCRIPTION OF EMBODIMENTS

Hereinafter, description shall be provided on the video signal processing device and the video signal processing method according to the present invention, with reference to the Drawings. It is to be noted that the present invention is determined by the recitation in Claims. Therefore, among constituent elements in the embodiments below, constituent elements not recited in the Claims are not necessary for achieving the object of the present invention. Specifically, the following embodiments are described as constituent elements comprising more favorable embodiments. Furthermore, each of the drawings is a schematic view and does not necessarily illustrate the real situation,

### Embodiment 1

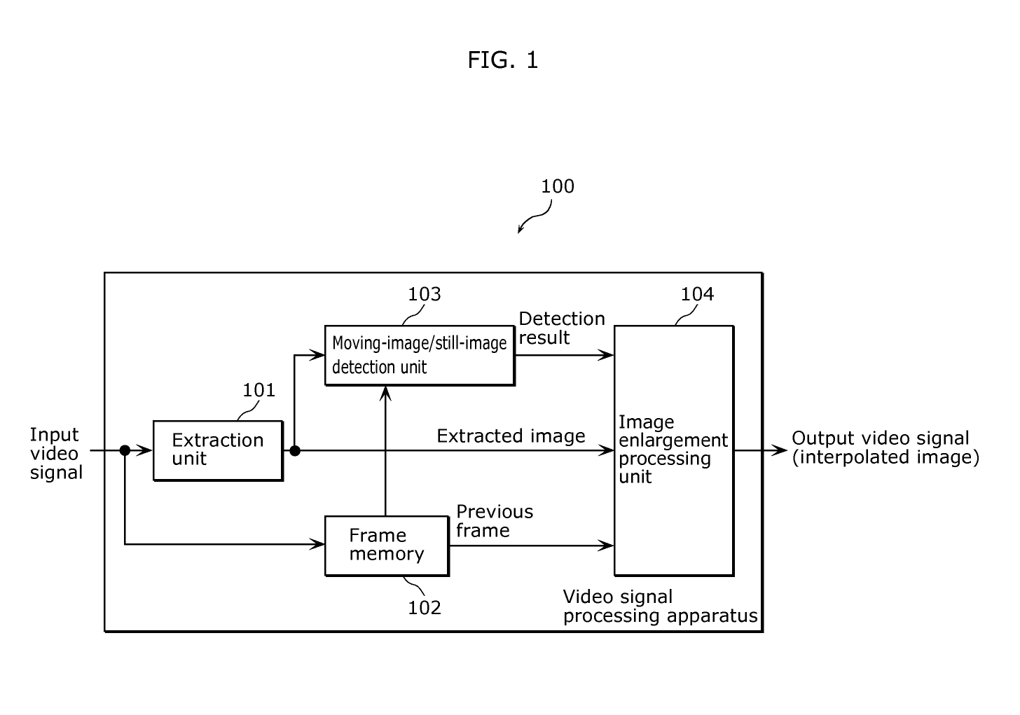

Description shall be provided on a video signal processing device according to Embodiment 1 with reference to FIG. 1 to FIG. 3,

FIG. 1 is a block diagram of a video signal processing device 100 according to Embodiment 1. The video signal processing device 100 includes, as shown in FIG. 1, an extraction unit 101, a frame memory 102, a moving-image/still-image detection unit 103, and an image enlargement processing unit 104.

The video signal processing device 100 converts an input video signal into an output video signal. The video signal processing device 100 is used as a television receiver, one of the parts of a set-top box, or a module part for business use. The video signal processing device 100 may be configured with software or hardware.

The input video signal is a video signal which includes at least a right-eye image and a left-eye image in each frame. Specifically, the input video signal is a three-dimensional video signal and is formed by the side-by-side scheme or the top-and-bottom scheme. The output video signal is a video signal which results from the processing on the input signal performed by the video signal processing device 100.

The extraction unit 101 extracts, from each frame included in the input video signal, one of the right-eye image and the left-eye image as an extracted image, and outputs the extracted image to the moving-image/still-image detection unit 103 and the image enlargement processing unit 104. The image to be extracted may be fixed preliminarily or determined according to an arbitrary scheme by the extraction unit 101 Furthermore, the extraction unit 101 may further detect whether each frame of the input video signals has a side-by-side structure or a top-and-bottom structure and inform the enlargement processing unit 104 of the detection result. The side-by-side structure is a structure in which the right-eye image and the left-eye image are arranged in the right and left. The top-and-bottom structure is the structure in which the right-eye image and the left-eye image are arranged in the top and bottom.

The frame memory 102 is a memory for storing the input video signal. The frame memory 102 has at least a capacity for storing signals for one frame out of the input video signals. The reading and writing of video signals by the frame memory 102 is controlled by a control device (not shown). Specifically, the frame memory 102 can be configured with a storage device such as a random access memory (RAM).

The moving image/still image detection unit (detection unit) 103 obtains input video signals for at least two temporally successive frames out of the input video signals, and detects whether each of co-located pixels in the two frames is a pixel included in the moving image (moving pixel) or a pixel included in the still image (still pixel). In Embodiment 1, the moving image/still image detection unit 103 obtains the extracted image from the extraction unit 101, and reads, from the frame memory 102, the image corresponding to the extracted image from a frame previous to the frame including the extracted image (typically, immediately previous frame). It is to be noted that “the image that corresponds to the extracted image” indicates the left-eye image in the previous frame when the extracted image is the left-eye image, and the right-eye image in the previous frame when the extracted image is the right-eye image.

Hereinafter, the input video signals input to each constituent element of the video signal processing device 100 are referred to as video signals of a current frame (or simply as “current frame”), and the input video signals read from the frame memory 102 are referred to as video signals of a previous frame (or simply as “previous frame”). It can be said that the video signal of the current frame can be a frame which is later in the time series (or in capturing order or display order) with respect to the video signal of the previous frame.

Next, description shall be provided on how the moving image/still image detection unit 103 detects the moving pixel and the still pixel. The signal level at arbitrary coordinates (x, y) in the video signals of the current frame is denoted as C(x, y). Here, x represents a horizontal coordinate of the pixel and y represents a vertical coordinate of the pixel. Likewise, the signal level at arbitrary coordinates (x, y) in the video signals of the previous frame is denoted as P(x, y). In this case, the moving image/still image detection unit 103 determines that a pixel C(x, y) at the coordinates is a moving pixel when the movement amount D obtained by Equation 1 below is greater than or equal to a threshold, and determines that the pixel C(x, y) at the coordinates is a still pixel when the movement amount D is smaller than a threshold.

D=|p(x, y)−C(x, y)| (Equation 1)

Here, a pixel to be compared when calculating the movement amount D may include information of one or more pixels, taking into consideration the effect of filtering with the peripheral pixels and grouping. Specifically, the horizontal coordinate x and/or the vertical coordinate y may have a certain range, and the movement amount D may be an average value of the range. Furthermore, the determination on the moving pixel and the still pixel may be made in a different manner. For example, information indicating that the entire frame is a still image may be obtained through an external signal input separately. Furthermore, although two frames continuous to each other are compared in Embodiment 1, two frames having certain interval therebetween may be compared.

The image enlargement processing unit 104 performs the enlargement processing by interpolating pixels into the extracted image. The image enlargement processing unit 104 interpolates pixels into the extracted image extracted by the extraction unit 101 using the pixel included in the current frame and the pixel included in the previous frame (more specifically, using one or more pixels in at least the previous frame). Then, the image enlargement processing unit 104 outputs the extracted image enlarged through the pixel interpolation (hereinafter referred to as “interpolated image”).

In Embodiment 1, the interpolation target image of the image enlargement processing unit 104 is the extracted image extracted by the extraction unit 101 out of the images included in the input video signals (that is one of the right-eye image and the left-eye image). The coordinates of the pixel on which the interpolation is performed (interpolation-target-pixel) by the image enlargement processing unit 104 is a pixel located at the space as a result of enlargement of the extracted image. Specifically, the image enlargement processing unit 104 interpolates the pixels in a direction in which the image is enlarged.

The pixel processed by the image enlargement processing unit 104 shall be described more specifically using the side-by-side scheme as an example. In the side-by-side scheme, the number of horizontal pixels included in an extracted image is half the number of horizontal pixels included in the proper image (interpolated image). Thus, the pixels in the horizontal direction become insufficient when the extracted image is enlarged to the proper image size. The image enlargement processing unit 104 performs pixel interpolation on the insufficient pixels. The image enlargement processing unit 104 in Embodiment 1 makes a space every other column of the extracted image and provides a vertical column into the space, as the enlargement processing on the side-by-side image. Then, the image enlargement processing unit 104 interpolates pixels into the provided vertical column.

Likewise, in the top-and-bottom image, the pixels in the vertical direction become insufficient. Thus, the image enlargement processing unit 104 interpolates pixels into the insufficient pixels in the vertical direction. In other words, a space is provided every other row of the extracted image and a horizontal row is provided to each space, and the image enlargement processing unit 104 interpolates pixels into the horizontal row. Furthermore, in a quincunx scheme in which the pixels are extracted in a hounds tooth pattern from the original left-eye image and right-eye image and input video signals are generated, the pixels become insufficient by half in both the horizontal direction and the vertical direction. Thus, the image enlargement processing unit 104 interpolates pixels into the insufficient pixels.

Next, description shall be provided on what pixels are used by the image enlargement processing unit 104 to interpolate the interpolation-target-pixels. It is assumed that the input video signal has the side-by-side structure, and that the left-eye image is extracted by the extraction unit 101. Specifically, a pixel included in the left-eye image (extracted image) is present at the position adjacent in the right and left to the interpolation-target-pixel. Thus, the image enlargement processing unit 104 adoptively switches the scheme for interpolating the interpolation-target-pixel adjacent to the pixel, according to the pixel value of the pixel included in the left-eye image.

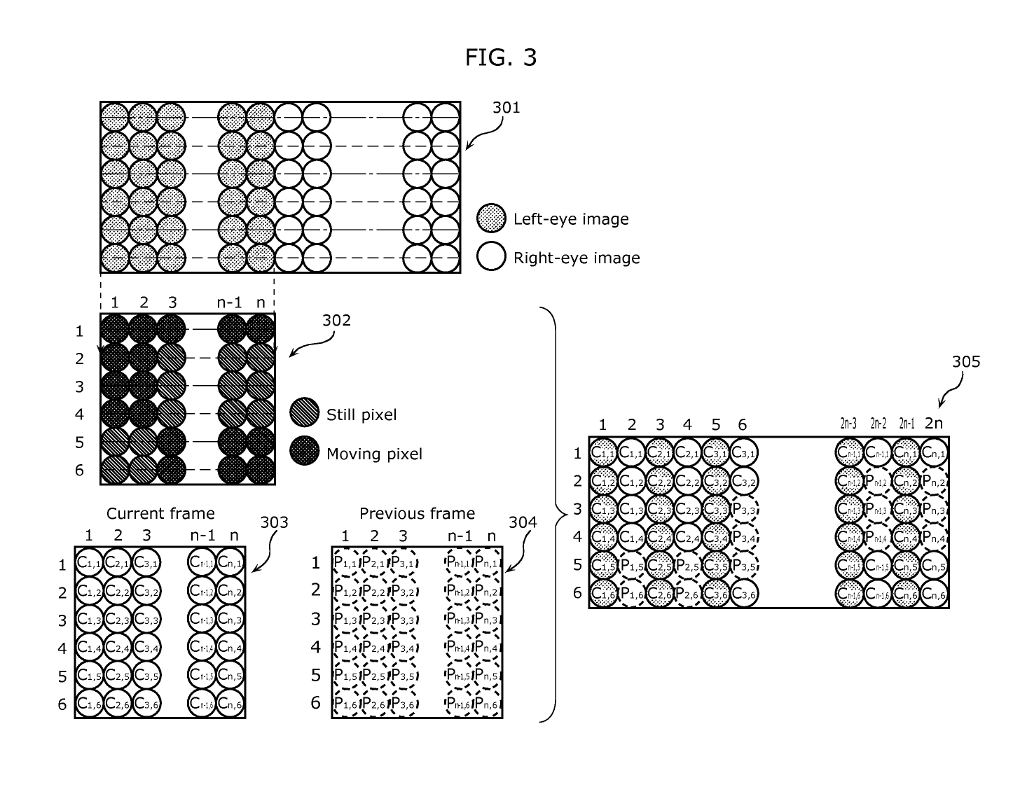

Firstly, the image enlargement processing unit 104 makes a space every other column of the interpolated image and places pixels included in the extracted image to the space. For example, the respective pixels of the extracted image are placed into the shaded columns (first column, third column, fifth column, (2n−3)-th column, and (2n−1)-th column) in the interpolated image 305 in FIG. 3. Specifically, when the signal level at the arbitrary coordinates (x, y) in the interpolated image is denoted as C′(x, y), the equality of Equation 2 below is held.

C′(2x−1, y)=C(x, y) (Equation 2)

Next, the image enlargement processing unit 104 interpolates the pixel-for-interpolation between the pixels included in the extracted image in the interpolated image (pixels other than the dashed pixels in the interpolated image in FIG. 3). In Embodiment 1, when a pixel C(x, y) at the arbitrary coordinates included in the left-eye image is the moving pixel, the image enlargement processing unit 104 interpolates a pixel C′(2x, y), which is at the coordinates adjacent to the right of the position (2x−1, y) of the pixel C(x, y), with the pixel C(x, y). Specifically, the image enlargement processing unit 104 copies the pixel C(x, y), which is determined as the moving pixel, to the interpolation-target-pixel C′(2x−y). Furthermore, when the pixel C(x, y) at arbitral coordinates included in the left-eye image is the still pixel, the image enlargement processing unit 104 interpolates a pixel P(x, y) at the coordinates of the left-eye image in the previous frame into the pixel C′(2x, y) at the coordinates adjacent to the right of the position (2x−1, y) of the pixel C(x, y) in the interpolated image.

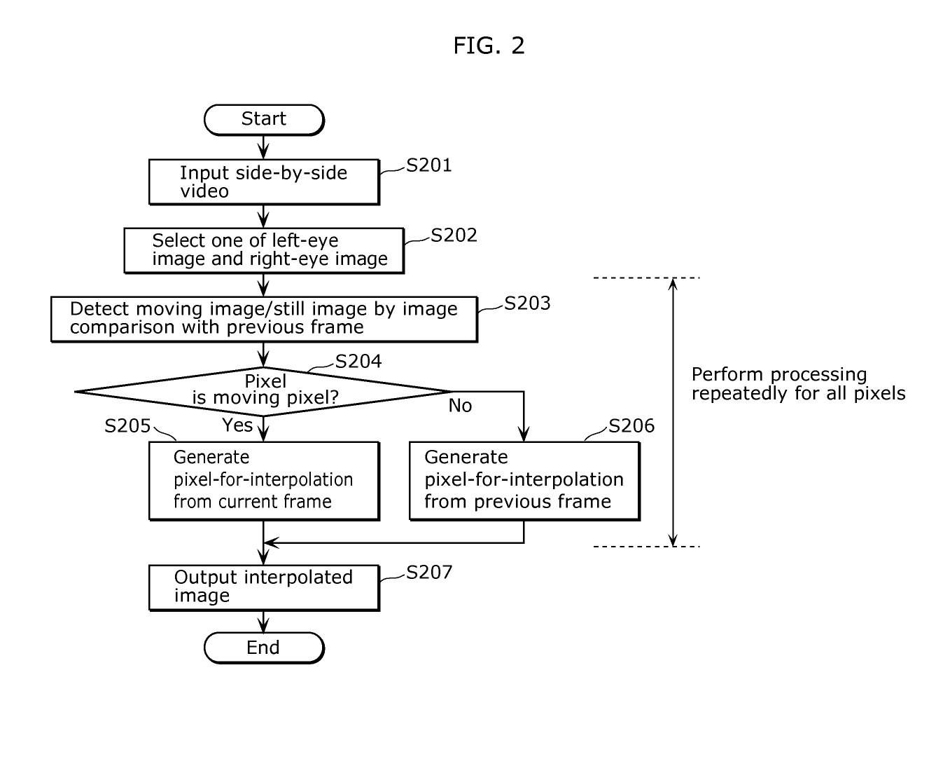

FIG. 2 is a flowchart of an image enlargement processing performed by the video signal processing device 100 in Embodiment 1. Hereinafter, description shall be provided along with the flowchart in FIG. 2.

Firstly, an input video signal having the side-by-side structure is input to the extraction unit 101 and the frame memory 102 of the video signal processing device 100 (S201).

Then, the extraction unit 101 selects, out of the images included in the input video signal, one of the right-eye image and the left-eye image as the extracted image on which the image enlargement processing is to be performed. Then, the extraction unit 101 outputs the selected extracted image (left-eye image) to the moving image/still image detection unit 103 and the image enlargement processing unit 104. Hereinafter, the description is provided based on an assumption that the left-eye image is selected as the extracted image. The same processing is performed when the right-eye image is selected as the extracted image.

Next, the moving image/still image detection unit 103 detects, for all the pixels of the extracted image selected in S202, whether the pixels are moving pixels or still pixels (S203). Specifically, the moving image/still image detection unit 103 calculates the movement amount D using Equation 1, for the respective corresponding pixels (pixels at the same positions) of the extracted image obtained from the extraction unit 101 (left-eye image in the current frame) and an image corresponding to the extracted image read from the frame memory 102 (the left-eye image in the previous frame). Then, the moving-image/still-image detection unit 103 determines that the pixel is the moving pixel when the calculated movement amount D is greater than or equal to a threshold, and that the pixel is the still pixel when the calculated movement amount D is smaller than the threshold.

The image enlargement processing unit 104 receives the result of detection (moving pixel or still pixel) in S203 from the moving-image/still-image detection unit 103 (S204).

When the pixel is the moving pixel (YES in S204), the image enlargement processing unit 104 provides, to immediately right of the pixel determined as the moving pixel in the interpolated image, the pixel as the pixel-for-interpolation (S205). Specifically, the image enlargement processing unit 104 performs interpolation using not the pixel present in the previous frame stored in the frame memory 102 but the pixel present in the input current frame. In this case, when it is assumed that the signal level of the interpolation-target-pixel is denoted as C′(2x, y) and the signal level of the pixel in the extracted image is denoted as C(x, y), the relational expression of the signal level in the interpolated image is as indicated in Equation 3 below,

C′(2x, y)=C(x, y) (Equation 3)

On the other hand, when the pixel is the still pixel (NO in S204), the image enlargement processing unit 104 provides, to immediately right of the pixel determined as the still pixel in the interpolated image, a pixel which is at the same coordinates as the pixel determined as the still pixel and in the previous frame, as the pixel-for-interpolation (S206). Specifically, the image enlargement processing unit 104 performs interpolation using the pixel in the previous frame stored in the frame memory 102. In this case, when it is assumed that the signal level of the interpolation-target-pixel is denoted as C′(2x, y) and the signal level of the pixel in the previous frame is denoted as P(x, y), the relational expression of the signal level in the interpolated image is as indicated in Equation 4 below.

C′(2x, y)=P(x, y) (Equation 4)

It is to be noted that, in S205 and S206, the position into which the image enlargement processing unit 104 interpolates the pixel is not limited to the right. When the input video signal has the side-by-side structure, it is sufficient to perform interpolation in the horizontal direction of the pixel detected by the moving-image/still-image detection unit 103. It is beneficial that the direction into which the pixel interpolation is performed is switched according to the image enlargement scheme.

In other words, when the image enlargement is performed with regarding: the first column which is the leftmost column in the interpolated image as the pixels of the extracted image; the second column which is adjacent to the right of the first column as the pixels-for-interpolation; the third column as the pixels of the extracted image, . . . , it is beneficial to perform interpolation to the right (that is, to perform interpolation using the pixels in the left of the interpolation-target-pixel). In contrast, when the first column is used as the pixels-for-interpolation, it is beneficial to perform interpolation to the left (that is, to perform interpolation using the pixels in the right of the interpolation-target-pixel). This is because it is beneficial to fill all of the coordinates with pixels through pixel interpolation.

It is to be noted that when the input video signal is formed by the top-and-bottom scheme, the image enlargement processing unit 104 performs pixel interpolation to the top or the bottom interpolation-target-pixel (that is, performs pixel interpolation using pixels in the top or the bottom of the interpolation-target-pixel).

After performing processing of S204 to S206 on all of the pixels, the image enlargement processing unit 104 outputs the image after pixel interpolation as the interpolated image, and finishes the image enlargement processing (S207).

Processing performed in S201 to S207 shall be described with reference to FIG. 3. FIG. 3 illustrates an example of an image when the image enlargement processing (processing in FIG. 2) is performed by the video signal processing device 100 according to Embodiment 1.

The input image 301 indicates the arrangement of pixels in one frame included in the input video signal input in S201. Since the input image 301 is a video signal having the side-by-side structure, the left-eye image is located in the left half and the right-eye image is located in the right half.

A moving-pixel/still-pixel detection result 302 indicates a concept of an arrangement example of the moving pixel and the still pixel on the left-eye image in the input image 301 detected by the moving-image/still-image detection unit 103 in S203. Specifically, in S203, determination on moving pixel/still pixel is made for every pixel in the extracted image. It is assumed that the left-eye image is selected as the extracted image in S202.

The interpolated image 305 indicates an arrangement of pixels after the image enlargement processing unit 104 performed, on the left-eye image 303 of the current frame input in S201, pixel interpolation using the left-eye image 303 of the current frame and the left-eye image 304 of the previous frame in S204 to S207. The image enlargement processing shall be described further, taking as an example several pixels out of the interpolated image 305.

For example, the moving-pixel/still-pixel detection result 302 indicates that the pixel C(1, 1) in the left-eye image 303 of the current frame is a moving pixel. The pixel C(1, 1) is in the first column from the left and the first row from the top. Thus, the pixel C′(2, 1) in the interpolated image 305 is interpolated with the pixel C(1, 1) of the current frame. The pixel C′(2, 1) is in the second column from the left and the first row from the top. As another example, the moving-pixel/still-pixel detection result 302 indicates that the pixel C(3, 4) in the left-eye image 303 of the current frame is a still pixel. The pixel C(3, 4) is in the third column from the left and the fourth row from the top. Thus, the pixel C′(6, 4) in the sixth column from the left and the fourth row from the top in the interpolated image 305 is interpolated with the pixel P(3, 4) in the left-eye image 304 of the previous frame.

In this manner, the video signal processing device 100 in Embodiment 1 performs interpolation using not only the pixels in the current frame but also the pixels in the previous frame. Thus, the fineness of the proper image is less likely to be lowered as compared with that of the interpolation scheme in which the pixel in the current frame is simply increased in the horizontal direction. This results in outputting a video (interpolated image) which is less likely to make the viewer have uncomfortable feeling.

The interpolation in Embodiment 1 was performed using not only the pixel in the previous frame but also the pixel in the current frame according to the detection result of the moving-image/still-image detection unit 103. However, it is possible to output the video (interpolated image) which is less likely to make the viewer have uncomfortable feeling even when the interpolation is performed always using the pixel in the previous frame.

Furthermore, the video signal processing device 100 according to Embodiment 1 performs interpolation using the pixel in the previous frame especially when the pixel in the current frame is a still pixel. This allows, in the still pixel which is likely to make the viewer have uncomfortable feeling, particularly effectively outputting the video (interpolated image) which is less likely to make the viewer have uncomfortable feeling.

Furthermore, the video signal processing device 100 according to Embodiment 1 performs interpolation using the pixel in the current frame especially when the pixel in the current frame is a moving pixel. This allows preventing the use of a pixel in the previous frame at a time of scene change and so on. This reduces the risk of collapse of the interpolated image.

Furthermore, in S205, the pixel value of the interpolation-target-pixel may be generated from the pixel in the right and the pixel in the left of the interpolation-target-pixel. In this case, when the signal level of the interpolation-target-pixel is denoted as C′(2x, y), and the signal level of the pixel for use in interpolation of the current frame is denoted as C(x, y) and C(x+1, y), the relational expression of the signal level in the image after interpolation is as indicated in Equation 5 below.

C′(2x, y)=α×C(x, y)+(1−α)×C(x+1, y) (Equation 5)

Here, it is assumed that a weight coefficient α is smaller than or equal to 1. With this, a difference in signal level occurs between the interpolation-target-pixel and the pixels adjacent to the interpolation-target-pixel in both sides. Thus, the flat feeling in the interpolated image is reduced, which is less likely to make the viewer have uncomfortable feeling. Furthermore, it is beneficial that the value of the weight coefficient α is set to 0.5 in order to equalize the effect of the pixels in the right and left of the interpolation-target-pixel.

Furthermore, in S206, a pixel obtained by combining (blending) the pixel included in the current frame and the pixel included in the previous frame may be used as the pixel-for-interpolation. In this case, when (i) the signal level of the interpolation-target-pixel is denoted as C′(2x, y), (ii) a signal level of the pixel for use in interpolation of the current frame is denoted as C(x, y), and (iii) the signal level of the pixel for use in interpolation of the previous frame is denoted as P(x, y), the relational expression of the signal level in the interpolated image is as indicated in Equation 6 below.

C′(2x, y)=α×C(x, y)+(1−α)×P(x, y) (Equation 6)

Here, it is assumed that the weight coefficient α is smaller than or equal to 1. This reduces the flat feeling of the interpolation-target-pixel and the pixel adjacent to the interpolation-target-pixel, which is less likely to make the viewer have uncomfortable feeling. Furthermore, it is beneficial that the value of the weight coefficient α is greater than or equal to 0.5 in order to increase the effect of the pixel in the current frame.

### Embodiment 2

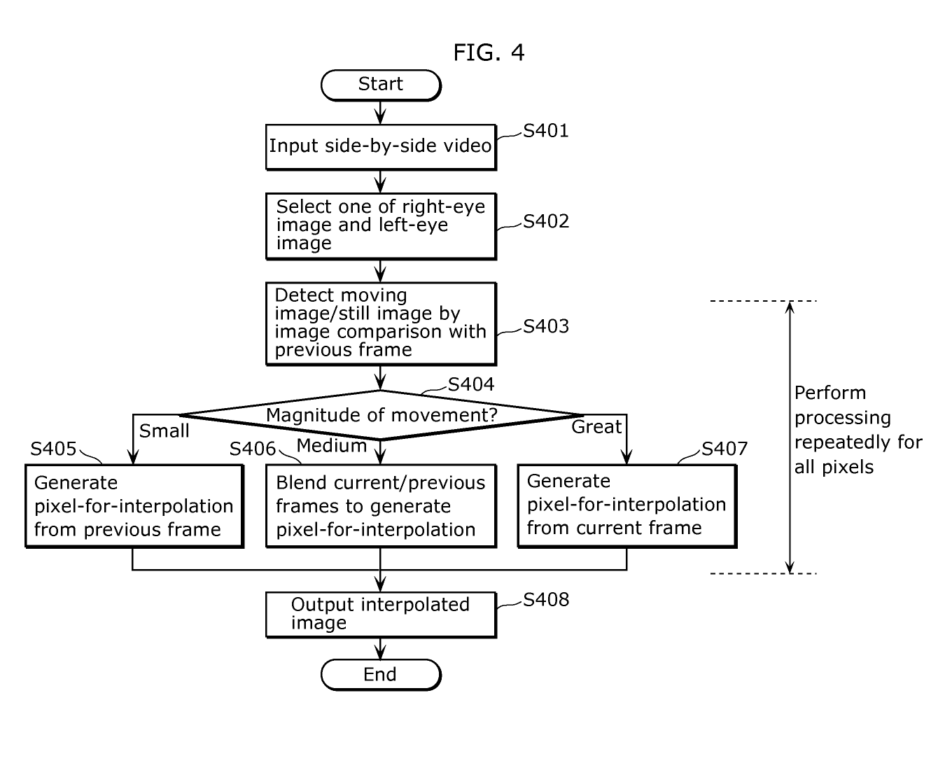

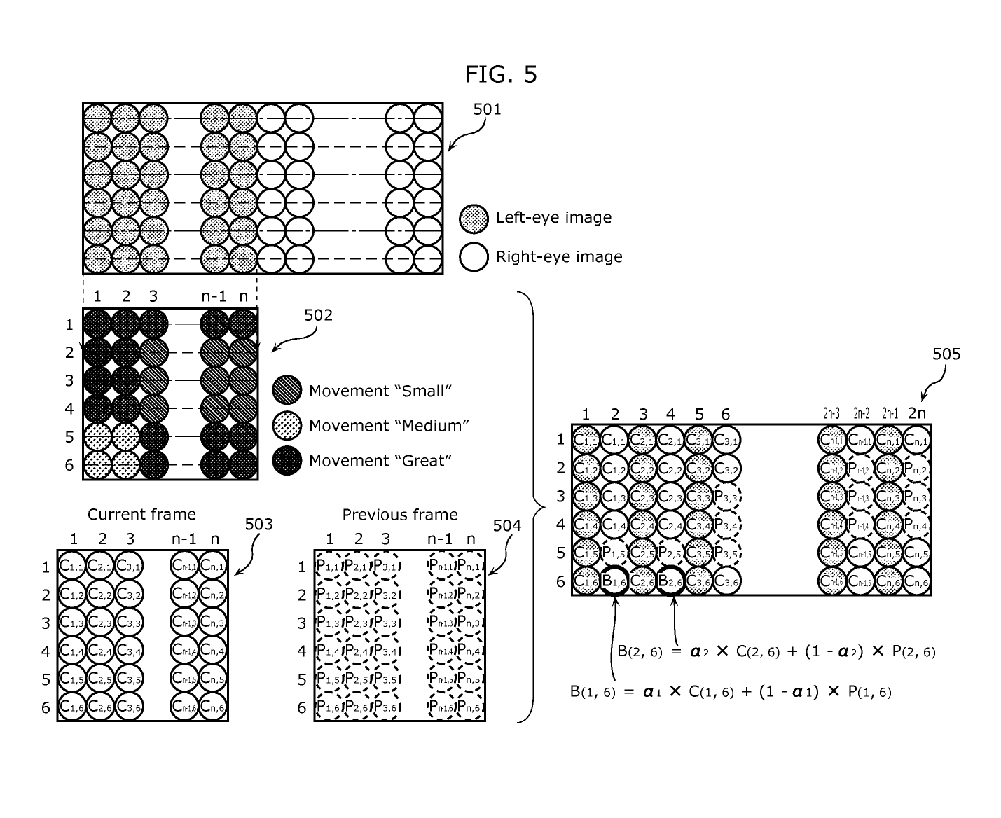

Next, Embodiment 2 shall be described with reference to FIG. 4 and FIG. 5. FIG. 4 is a flowchart of an image enlargement processing according to Embodiment 2. FIG. 5 illustrates an example of an image when the image enlargement processing in FIG. 4 is performed. It is to be noted that since the structure of the video signal processing device according to Embodiment 2 is common to that shown in FIG. 1, the description is not repeated. Furthermore, in the image enlargement processing in FIG. 4, the processing common to that in FIG, 2 is omitted and description is provided focusing on the different point.

In Embodiment 2, in addition to Embodiment 1, the moving-image/still-image detection unit 103 sets an intermediate value of the moving pixel and the still pixel for a pixel which has a relatively small movement among the pixels determined as the moving pixels in Embodiment 1 (in other words, a pixel which has a relatively great movement among the pixels determined as the still pixels in Embodiment 1). Specifically, steps S404 to S407 in FIG. 4 are different from those in FIG. 2, and steps S401 to S403 and S408 are common to steps S201 to S203 and S207 in FIG. 2.

Specifically, in S404 in FIG. 4, the image enlargement processing unit 104 determines, for each of the pixels included in the extracted image, the magnitude of the movement amount D calculated by Equation 1, and selects the pixel for use in interpolation according to the result of the determination.

When the movement amount D is smaller than a first threshold (“Small” in S404), the image enlargement processing unit 104 generates a pixel-for-interpolation using the pixel in the previous frame (S405). Furthermore, when the movement amount D is greater than or equal to the first threshold and smaller than a second threshold(>first threshold) (“Medium” in S404), the image enlargement processing unit 104 blends the pixel in the current frame and the pixel in the previous frame to generate the pixel-for-interpolation (S406). Moreover, when the movement amount D is greater than or equal to the second threshold (“Great” in S404), the image enlargement processing unit 104 generates the pixel-for-interpolation using the pixel in the current frame (S407).

In the example shown in FIG. 5, the moving-pixel/still-pixel detection result 502 indicates that the movement of the pixel C(1, 6) in the extracted image is determined as “Medium”. Thus, at a pixel having the coordinates (2, 6) in the interpolated image, a pixel B(1, 6) is located which is obtained by blending the pixel C(1, 6) in the current frame and the pixel P(1, 6) in the previous frame. It is to be noted that a weight coefficient α₁ for use in blending may be changed according to the magnitude of the movement amount D, for example. For example, the weight coefficient α₁ may be increased as the movement amount D is greater, to increase the effect (weight) of the pixel in the current frame. Specifically, if it is determined “Small” in S404, when the weight coefficient α₁ is set to α₁=0, the processing matches the processing in S405. In contrast, if it is determined as “Great” in S404, when the weight coefficient α₁ is set to α₁=1, the processing matches the processing in S407.

Although three distinct types of processing are used according to the magnitude of the movement amount D in the example in FIG, 4, the present invention is not limited to the example. For example, when the movement amount D calculated by Equation 1 is: smaller than the first threshold, the pixel is determined as the still pixel(=moving image level 0); greater than or equal to the first threshold and smaller than the second threshold, it is determined that the moving image level of the pixel is 0.25; greater than or equal to the second threshold and smaller than the third threshold, it is determined that the moving image level of the pixel is 0.5; greater than or equal to the third threshold and smaller than the fourth threshold, it is determined that the moving image level of the pixel is 0.75; and greater than or equal to the fourth threshold, the pixel is determined as the moving pixel(=moving image level 1).

Furthermore, in the case of operation in Embodiment 1 in which the side-by-side image is doubled, the pixel in the current frame and the pixel in the previous frame may be combined at a ratio according to the moving image level as in Equation 7 below, instead of the operation (S205 and S206) in Embodiment 1.

C′(2x, y)=moving image level×C(x, y)+(1−moving image level)×P(x, y) (Equation 7)

The interpolation scheme described in Embodiment 1 and Embodiment 2 may also be applied for the top-and-bottom image by switching the horizontal direction and the vertical direction. Furthermore, the moving image level may be fixed and used separately from the detection result. Fixing the moving image level indicates that it is possible to generate all of the interpolation-target-pixels using the video signal of the previous frame.

The application of the interpolation processing in Embodiments 1 and 2 is not limited to the case where the 3D image is converted into the 2D image. For example, when the right-eye image and the left-eye image are alternately output as a 3D video, the interpolation processing can be applied for interpolating the right-eye image and left-eye image to be output. In this case, the extraction unit 101 outputs the left-eye image in the current frame as the extracted image, and then outputs the right-eye image in the current frame as the extracted image.

Furthermore, in the enlargement processing for the case where the display size (aspect ratio) of the display is different from that of the input video size, the processing can be applied by changing, according to the enlargement ratio, the combination ratio of the pixels to be provided. For example, the interpolation for the case where the enlargement ratio is 1.5 times is as indicated in Equation 8 below.

C′(2x, y)={1/3×C(x, y)+2/3×C(x+1, y)}×moving image level+{1/3×P(x, y)+2/3×P(x+1, y)}×moving image level (Equation 8)

Regarding the generation of the pixel-for-interpolation, although the interpolation scheme using the two-tap (between two pixels) filters is used in all the cases above, the same object can be achieved with a filter using the two-dimensional direction (peripheral pixels in horizontal and vertical directions) by changing the combination ratio of the pixel in the previous frame and the pixel in the current frame according to the result of determination by the moving image/still image detection unit 103.

It is to be noted that although the present invention is described based on the aforementioned embodiments, the present invention is obviously not limited to such embodiments. The following cases are also included in the present invention.

Specifically, each of the aforementioned devices can be implemented with a computer system including a microprocessor, a ROM, a RAM, a hard disk unit, a display unit, a keyboard, a mouse, and the like. The RAM or the hard disc unit stores a computer program. The respective devices achieve their functions through the microprocessor's operation according to the computer program. Here, the computer program is configured by combining a plurality of instruction codes indicating instructions for the computer, in order to achieve predetermined functions.

A part or all of the constituent elements constituting the respective devices may be configured from a single System-LSI (Large-Scale integration). The System LSI is a super multifunctional LSI manufactured by integrating plural constituent elements on a single chip, and is specifically a computer system including a microprocessor, a ROM, a RAM, and so on. The ROM stores a computer program. The system LSI achieves its function through the microprocessor's operation according to the computer program.

Some or all of the constituent elements included in each of the respective devices may be configured as an IC card which can be attached and detached from the respective devices or as a stand-alone module. The IC card or the module may be a computer system including the microprocessor, the ROM, the RAM, and the like. The IC card or the module may also be included in the aforementioned super-multi-function LSI. The IC card or the module achieves its function through the microprocessor's operation according to the computer program. The IC card or the module may have tamper resistant.

The present invention may be a method of the above. The present invention may be a computer program for realizing the previously illustrated method, using a computer, and may also be a digital signal including the computer program.

Furthermore, the present invention may be realized by a computer-readable recording medium in which computer programs or digital signals are recorded, such as a flexible disk, hard disk, CD-ROM, MO, DVD, DVD-ROM, DVD-RAM, BD (Blu-ray Disc), and a semiconductor memory. Furthermore, the present invention also includes the digital signal recorded in these recording media.

Furthermore, the present invention may also be realized by the transmission of the aforementioned computer program or digital signal via a telecommunication line, a wireless or wired communication line, a network represented by the Internet, a data broadcast, and so forth.

The present invention may also be a computer system including a microprocessor and a memory, in which the memory stores the aforementioned computer program and the microprocessor operates according to the computer program,

Furthermore, by transferring the program or the digital signal by recording onto the aforementioned recording media, or by transferring the program or digital signal via the aforementioned network and the like, execution using another independent computer system is also made possible.

Each of the above embodiments and modification examples may be combined.

Although the embodiments of the present invention have been described with reference to the Drawings, the present invention is not determined by the embodiments illustrated. Various modifications or variation may be added to the above embodiments in the scope equal to the present invention or in the scope of equality.

### INDUSTRIAL APPLICABILITY

The present invention is used advantageously for a video signal processing device which interpolates a pixel into each of images included in the obtained video and outputs the interpolated image,

### REFERENCE SIGNS LIST

100 Video signal processing device
101 Extraction unit
102 Frame memory
103 Moving-image/still-image detection unit
104 Image enlargement processing unit
301, 501 Input image
302, 502 Moving-pixel/still-pixel detection result
303, 503 Left-eye image in current frame
304, 504 Left-eye image in previous frame
305, 505 Interpolated image

1. A video signal processing device which enlarges an image and outputs the enlarged image, the video signal processing device comprising:
an extraction unit configured to extract, from each frame of an input video including a right-eye image and a left-eye image, one of the right-eye image and the left-eye image as an extracted image; and
an image enlargement processing unit configured to (i) form an interpolated image by enlarging the extracted image extracted by the extraction unit, through pixel interpolation using a pixel included in a previous frame, and (ii) output the interpolated image, the previous frame being a frame previous to the frame including the extracted image.

2. The video signal processing device according to claim 1, further comprising
a detection unit configured to detect, for each of a plurality of pixels included in the extracted image, whether a current pixel is a moving pixel which moves no less than a predetermined threshold or a still pixel which moves less than the predetermined threshold,
wherein the image enlargement processing unit is configured to generate, for each of the pixels included in the extracted image: when it is determined by the detection unit that the current pixel is the moving pixel, a pixel value of a pixel adjacent to the current pixel in the interpolated image using a pixel value of the current pixel; and when it is determined by the detection unit that the current pixel is the still pixel, a pixel value of a pixel adjacent to the current pixel in the interpolated image using a pixel value of a pixel that is included in the previous frame and corresponds to the current pixel.

3. The video signal processing device according to claim 1, further comprising
a detection unit configured to detect, for each of a plurality of pixels included in the extracted image, a movement amount which is a magnitude of movement of a current pixel,
wherein the image enlargement processing unit is configured to (i) blend, for each of the pixels included in the extracted image, a pixel value of the current pixel and a pixel value of a pixel that is included in the previous frame and corresponds to the current pixel to increase a weight of the current pixel as the movement amount detected by the detection unit is greater, and (ii) generate a pixel adjacent to the current pixel in the interpolated image.

4. The video signal processing device according to claim 1,
wherein the extraction unit is further configured to inform the enlargement processing unit of whether each frame of the input image has a side-by-side structure or a top-and-bottom structure, the side-by-side structure having the right-eye image and the left-eye image arranged in the right and left, the top and bottom structure having the right-eye image and the left-eye image arranged in the top and bottom, and
the image enlargement processing unit is configured to:
when the frame of the input video has the side-by-side structure, interpolate in the interpolated image a pixel at a position adjacent in a right-and-left direction to each pixel included in the extracted image, and
when the frame of the input video has the top-and-bottom structure, interpolate in the interpolated image a pixel at a position adjacent in a top-and-bottom direction to each pixel included in the extracted image.

5. A video signal processing method of enlarging an image and outputting the enlarged image, the video signal processing method comprising:
extracting, from each frame of an input video including a right-eye image and a left-eye image, one of the right-eye image and the left-eye image as an extracted image; and
(i) forming an interpolated image by enlarging the extracted image extracted in the extracting, through pixel interpolation using a pixel included in a previous frame, and (ii) outputting the interpolated image, the previous frame being a frame previous to the frame including the extracted image.
